(19) United States
(12) Patent Application Publication
(10) Pub. No.: US 2008/0192069 A1
(43) Pub. Date: Aug. 14, 2008

(54) DATA ANALYSIS

(76) Inventors: Detlev WANZKE, Frankfurt (DE); Lothar Wanzke, Frankfurt (DE)

Correspondence Address: STITES & HARBISON PLLC, 1199 NORTH FAIRFAX STREET, SUITE 900, ALEXANDRIA, VA, 22314, US

(21) Appl. No.: 12/017,908

(22) Filed: Jan. 22, 2008

(30) Foreign Application Priority Data
Jan. 22, 2007 (GB) 0701202.4

(51) Int. Cl. G09G 5/00; G06T 11/20

(52) U.S. Cl. 345/619; 345/440

(57) ABSTRACT

The invention provides a charting method in which a plurality of segments of a data series are selected and plotted on a chart, the segments being overlaid on one another on the chart. The segments to be plotted can be selected using one or more filters.

### FIELD OF THE INVENTION

This invention has to do with methods and software tools for analysing data. It is particularly concerned with the analysis of collections of data such as data series, and is useful for example in the analysis of time series i.e. series of data that (potentially) vary over time.

The invention has particular, although not necessarily exclusive, application in the analysis of financial data such as stock performance indices, exchange rates and other financial series. It is also useful for the analysis of other data including, by way of example only, risk analysis data (e.g. for securities), economic data, ecological data, biological data, medical data, etc.

Preferred embodiments of the invention are especially useful in the analysis of the dependencies between two or more time series, for example a financial series and a series of data point representing some other factor (e.g. investor sentiment), as well as in the analysis of seasonal variations in time series.

### BACKGROUND

Financial analysts are tasked with predicting the future performance of financial series, e.g. individual stock prices and stock indices such as the DAX, FTSE 100, DJIA (Dow Jones Industrial Average), etc. Typically their work involves analysing the past performance of the relevant financial series, looking for patterns in the series, including seasonal variations and responses to external factors such as investor sentiment. Once patterns are identified, they can be used to predict future performance.

When looking for dependencies between two time series, for example, a typical approach is to plot the two time series together on a chart, identify points of interest in one of the time series (e.g. peaks) and then to look at the other time series adjacent the points of interest in the first chart to look for any commonality in those regions of the second series immediately before and/or after each identified point of interest in the first series.

This approach, carried out manually by the analyst, is exemplified in FIG. 1, which shows plots of investor sentiment (based on a weekly survey) and the DAX over a time period of about 1 year.

The expectation is that sentiment and DAX can be correlated in multiple ways. For instance, if sentiment is low it is likely that the DAX will fall. If, on the other hand, sentiment is high then the DAX is likely to rise, although if the sentiment is too high then the DAX may well fall because the buying interest in the market is likely to have reached a peak. These, and other, dependencies should, in theory, be apparent in the chart of the two time series.

The problem for the analyst, however, is not only to identify such possible correlations between the two series but also to quantify the likely rise or fall of one of the curves (in this case the DAX) based on the current state of the other series (investor sentiment). For instance, if faced with a scenario where the DAX is perceived to be too high, it is generally not sufficient for an analyst to predict a fall in the DAX. The expectation is that they will predict whether the DAX will fall by e.g. one, two or three percent and also that they will predict how long the bearish scenario will remain (e.g. one, two or three weeks).

Again looking at the specific example shown in FIG. 1, the approach taken by the analyst will typically be to mark points of interest in one of the series, in this example peaks in excess of a sentiment level of ‘+40’ in the sentiment data series, which have been circled. They will then try to determine an associated pattern in the change in the DAX immediately after these peaks, in the present example perhaps reaching the conclusion that the first two peaks can be discounted for some reason and that based on a comparison of the current situation (the right-hand end of the chart) with the third peak in the sentiment chart they may then forecast that the DAX will fall.

Other analysis techniques involve potentially costly and drawn out statistical analysis, e.g. regression analysis, often with inconclusive results.

Generally, therefore, analysts will prefer to rely on their own, subjective, analysis. As will be appreciated from the above however, the prediction of future performance (‘forecasting’) is far from straightforward. Consequently, especially in recent times, there has been much scepticism about the value of this analysis work.

Similar problems are faced when analysing other data, both in the financial field and in other non-financial fields.

### SUMMARY OF THE INVENTION

The present invention is generally concerned with computer algorithms, charting methods (including computer implemented charting methods) and tools that can be used by e.g. analysts to improve the quality of their forecasts of the future performance of e.g. financial series, by allowing them to quickly and accurately analyse data (e.g. data series), including for example patterns within a data series and/or the dependencies between them.

### Plotting Multiple Segments

A general proposition of the present invention is to plot (and normally display) multiple segments of the same data series (e.g. time series) or multiple segments from different data series in a single chart overlaid on one another. In this way an analyst can more easily look for repeating patterns or trends in the overlaid segments.

The term “segment” in this context is intended to mean a single data point or a sequence of two or more, preferably consecutive, data points in a data series (e.g. a time series).

Accordingly, in a first aspect the invention provides a charting method comprising selecting a plurality of segments of one or more data series and plotting the segments on a chart, the segments being overlaid on one another on the chart.

Preferably at least two or more of the overlaid segments are from the same data series as one another.

The data series may be time series.

Whilst this approach can be beneficial with any number of overlaid segments (e.g. even with only two or three segments overlaid, a trend may be apparent), it will generally be preferable to select and overlay five or more segments of the data series, for instance, 5, 6, 7, 8, 9, 10, 20, 30, 40, 50 or even more segments. In some applications of the method it may be appropriate to select and overlay 100 or more segments of a data series, or even as many as 500 or 1,000 or more.

In some embodiments all of the overlaid data series may be selected from a single data series. In other embodiments the segments may be selected from a multiple data series.

The overlaid segments of the chart will typically be plotted to the same scale as one another to enable their direct comparison.

It is also preferred that all of the segments are the same ‘length’ as one another, e.g. in the case of a time series, the same time period, for example the same number of hours, days (e.g. calendar days or trading days), months, years, etc. Generally this will also mean that each of the segments contains the same number of data points as each of the other segments, although this need not necessarily be the case. Embodiments of the invention can also be applied to time series in which the frequency of the sampled data points varies over time.

### Normalisation

In some embodiments, the values of the data series (e.g. time series) within each segment will be normalised about a selected point (e.g. value) in the segment, preferably the same relative point (e.g. value) within each segment, so all of the overlaid segments coincide at that point on the chart.

The selected point may, for example, be the start point (e.g. earliest time point in the case of a time series) of the segment, the end point or any selected point in between.

The chosen point about which to normalise the values of each segment may be arbitrarily selected or it may have some special significance, as exemplified by the “decision points” referred to below in the discussion of criteria for selecting the segments of the data series (e.g. time series) to chart.

### Statistical Functions (‘Indicators’)

The method preferably also includes calculating one or more statistical functions (sometimes referred to as indicators), derived from the selected segments of the data series, and overlaying the or each indicator on the chart. The indicators may, for example, be one or more of a mean, median or other percentile of the points in all of the plotted segments.

When the plotted chart is displayed, the indicator(s) may be displayed along with the underlying data series segments or, in some cases, it may be preferable to display only the indicator(s), especially for example where there are a large number of plotted segments (e.g. 500 or 1,000) that would result in a cluttered display that was difficult to interpret.

In fact, where it is appropriate to display only the indicators and there is no desire or requirement to display the underlying data series segments, then the segment data itself need not be plotted on the chart. Rather, it can be used to calculate the one or more indicators, only the indicator(s) being plotted (and displayed) on the chart.

Accordingly, in a second aspect, the invention proposes a charting method comprising selecting a plurality of segments of one or more data series, deriving collectively from all of the selected segments one or more statistical functions and plotting said one or more statistical functions on a chart.

The data series may be time series.

The statistical function may, for example, be the mean or median or another percentile of corresponding points (e.g. in time in the case of a time series) in each of the data series segments. Preferably at least the mean, the median and/or one or more percentiles are plotted on the chart.

Optionally in this second aspect, one or more of the underlying data series segments may also be plotted on the chart.

In both of the aspects above, the indicators may be shown as colored (or otherwise visually distinguished) bands representing bands of values for the indicator. Taking the example of median and other percentile values, the chart may have a series of differently colored bands representing the regions: between the median (50^{th} percentile) and 30^{th} percentile; between the 30^{th} percentile and 10^{th} percentile and below the 10^{th} percentile for example.

This approach to displaying the statistical functions (‘indicators’) may be particularly useful where data series segments and statistical functions derived from them are to be displayed on the same chart. For instance, the data series (e.g. time series) segments may be plotted and displayed as lines with the statistical functions plotted and displayed as colored bands in the background.

### Selection of Segments (“Filtering”)

The data series segments may be selected based on criteria defined by a user or automatically (e.g. based on a current state of the data series that is being examined). The criteria used for selection of the segments from a data series may relate to the data series itself or to another data source.

For instance, to exemplify the case where the criteria are based on a time series itself, seasonal variations in a time series may be examined by selecting segments consisting of data for two or more consecutive years (calendar years or starting at some other point in a calendar year, e.g. to coincide with a tax year), each segment being a year in length.

Other examples of such internal dependencies include, for example, an analysis of the dependency of a data series on indicators (e.g. moving average, Bollinger bands, etc) calculated from the data series or the results of other technical analysis of the data series, e.g. trend lines, support and resistance lines. etc. For instance, an analyst might want to look at what happens when a time series passes the moving average and/or Bollinger bands in one direction or the other.

The approach might also be used to look at simple data series patterns, such as what happens after a drop of a certain value, or to look at more complex patterns such as what happens following particular recognizable patterns, e.g. a shoulder-body-shoulder pattern or a flag constellation to give two of many possible examples.

Where embodiments of the method are being used to investigate dependencies between more than one data series (e.g. more than one time series), the criteria for selecting segments from one of the series may relate to the other of the series.

For instance, considering the case where an analyst is looking for dependencies between the DAX and investor sentiment, they may choose to look at segments of the DAX time series that correspond (in time) to particular features of interest in the sentiment time series, e.g. where the sentiment value climbs a certain number of points without exceeding a particular ceiling value.

Another example would be to look at the dependency of a data series on indicators (e.g. moving average, Bollinger bands, etc) calculated from the other data series or the results of other technical analysis of the other data series, e.g. trend lines, support and resistance lines, etc. (e.g. to look at the DAX and the moving average of the DOW or to look at the DAX and particular events in the DOW series in relation to its moving average—e.g. the DOW crossing its moving average).

In some cases, the use of criteria to select segments of a data series in this way may amount to breaking down a data series into a number of consecutive, non-overlapping chunks. One example is the seasonal variation analysis mentioned above in which a time series is broken down into consecutive, annual segments that are then overlaid on the chart.

However, the segments need not represent consecutive chunks of data in the series. They can be spaced from one another in the data series. They can also overlap one another (the same data point from a data series appearing in two or more of the selected segments). The segments selected to examine any particular scenario may include examples of both segments that are spaced from one another and segments that overlap, as well as segments that (coincidentally or otherwise) follow consecutively one from the other in the overall data series.

In many cases, depending on the criteria used to select them, the relative positions within the overall data series of the selected segments will be of little or no consequence. Rather, the significance is that the data series has been filtered to identify and pick out (as individual segments) only those regions of the overall data series that are of significance to the scenario in question (as defined by the selection criteria). In this way the patterns of overlaid charted segments and indicators derived from them can give an accurate picture of any trends or dependencies in the selected segments with reference to the selection criteria. Conveniently, the criteria used for selecting the data series segments can be referred to as ‘filters’.

By examining a data series using a series of filters (i.e. a series of different segment selection criteria) in succession, a user can for example relatively quickly and accurately investigate dependencies between two data series or a data series and other internal or external factors on which the selection criteria are based.

Typically, the application of a filter (selection criteria) will first result in the identification of specific points in a data series satisfying the filter criteria, each identified point (referred to in the following as ‘decision points’) being a point about which a segment is to be defined.

To give one example, again taking the case of an analysis of the dependencies between the DAX and investor sentiment, decision points may be defined by the filter as all days in the DAX time series on which investor confidence climbed more that 10 points and is within the range −15 to +15.

Once the decision points have been identified, it is then necessary to build the segments around them. Each segment may be defined, for example, as the chunk of the data series represented by a predetermined length (e.g. time period or number of data points) before and/or after the decision point. The length of the segments selected in this way and the position of the decision point within each segment can be chosen by the user or preset (or otherwise derived dependent on the scenario that is being examined).

Whilst the decision point may be at the beginning or end of the segment, it is preferred that it is not.

As noted already above, where the data points in each segment are to be normalised before they are plotted, they may be normalised based on the value of the series at the respective decision point.

The concept of using filtering in the above manner to select one or more segments of a time series or other data series for further processing is of independent merit and differs from known filter mechanisms, which are used to select individual data points for further processing as opposed to data segments.

Accordingly, in a third aspect, the invention provides a method for filtering data series data, the method comprising identifying in the data series data one or more data points satisfying predetermined filter criteria and defining a corresponding one or more data series data segments comprising a respective one of the identified data points and one or more preceding data points from the series and/or one or more succeeding data points from the series.

The data series may be a time series.

The data segments that result from this novel filtering process can then be used for subsequent analysis, for example in the manner discussed further above.

The length (time duration or number of data points) of the data segments may be selected by the user or preset. Preferably all of the selected data segments are the same length.

In some cases it may be desirable to apply the filter criteria simply to identify data points (i.e. points of interest), which in the case of time series would be points in time) that can be used in a subsequent, separate process to select data segments in a date series (e.g. a time series). As discussed in more detail below, the filter criteria may be applied to one or more data series to determine the points of interest, the points of interest then being used to define segments in another data series.

In the various aspects of the invention set forth above, the data series may be time series, for example financial time series. Exemplary financial time series include stock exchange indices, stock prices, derivative prices, exchange rates, etc.

One exemplary application for embodiments of the present invention is in the analysis of seasonal variations in a financial series.

Another exemplary application is in the analysis of the dependency of a financial series on investor sentiment.

The invention is not, however, limited to these applications. It has general applicability to the analysis of any data series, for example to look at patterns and/or dependencies on internally derived factors (e.g. indicators) or external factors (e.g. other data series).

In other aspects, the invention provides computer systems adapted for operating the methods set forth above.

In particular, in one further aspect, the invention provides a computer system adapted to operate a charting method according to the first aspect above, the system comprising means for selecting a plurality of segments of a data series and means for plotting the segments on a chart overlaid on one another.

In another aspect the invention provides a computer system adapted to operate a charting method according to the second aspect above, the system comprising means for selecting a plurality of segments of a data series, means for deriving collectively from all of the selected segments one or more statistical functions and means for plotting said one or more statistical functions on a chart.

In yet another aspect the invention provides a computer system adapted to operate a filtering method according to the third aspect above, the system comprising means identifying in data series data one or more data points satisfying predetermined filter criteria and means for defining a corresponding one or more data series data segments comprising a respective one of the identified data points and one or more preceding data points from the series and/or one or more succeeding data points from the series.

The invention also provides computer programs comprising computer program code that when executed on a computer or computer network causes the computer or computer network to operate in accordance with the methods set forth above.

### BRIEF DESCRIPTION OF THE DRAWINGS

Preferred embodiments of the invention are now described by way of example, with reference to the accompanying drawings in which:

FIG. 1 is chart showing two time series, the DAX (German stock market index) and a weekly survey measure of investor sentiment (prior art);

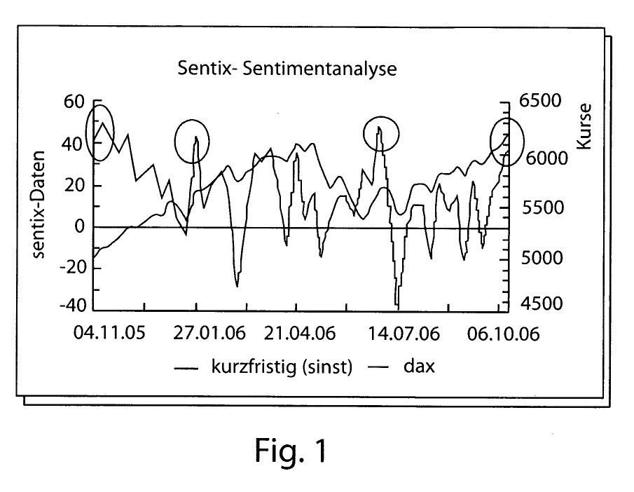

FIG. 2 is a screen shot illustrating displayed charts created in accordance with an embodiment of the present invention for use in the analysis of the dependency between two time series (DAX and investor sentiment);

FIG. 3 is a screen shot showing charts similar to those of FIG. 2, exemplifying another embodiment of the invention including a feedback feature (discussed below);

FIG. 4 is a screen shot illustrating the use of charts created in accordance with another embodiment of the invention to analyse the seasonal variation in a time series (DAX);

FIG. 5 is a screen shot similar to that of FIG. 4, illustrating another seasonal analysis embodiment of the invention additional employing ceiling filter (discussed below);

FIG. 6 is a screen shot showing an analysis carried out in accordance with an embodiment of the invention in which several scenario filters are used;

FIG. 7 is a screen shot of an editor that can be employed by a user to define a filter based on patterns, in accordance with an embodiment of the invention;

FIG. 8 is a screen shot showing charts including multiple time series (the time series of all stocks in the DAX in the illustrated example) with directly inputted events (i.e. decision points—‘DPs’);

FIG. 9 is a process diagram giving a basic overview of the operation of the embodiment of that can be used to create the chart of FIG. 2; and

FIG. 10 is another process diagram illustrating an embodiment of the invention in which multiple filters are used to determine the decision points (‘DPs’) to be used.

### DETAILED DESCRIPTION

The embodiments of the present invention described below illustrate the manner in which the invention can be used to provide meaningful charts that are useful in the analysis of time series, especially financial series. Various types of use are exemplified, including analysis of dependencies between two related (but different) time series and analysis of seasonal variations within a single time series. The examples below also illustrate different ways in which one or more filters can be employed in embodiments of the invention, as well as the analysis of multiple time series. The principles of the invention are, however, more widely applicable than this. As noted above, for example, embodiments of the invention are applicable to other types of data series.

In both cases exemplified below, embodiments of the invention are implemented as a program operating on a computer (e.g. a conventional personal computer such as a desktop computer, laptop computer, handheld computer or the like). The data series may be stored in memory associates with the computer (i.e. integral with or otherwise accessible by the computer). The computer program can also be stored in memory associated with the computer. Alternatively, the methods may be implemented by computer programs operating on a server computer accessible by the user from a client device (e.g. a personal computer, etc) over a communications network (e.g. a LAN or WAN—wired or wireless—e.g. the Internet). The computer program code may be executed by one or more processors of the computer (server or client) to implement the steps of the methods described below. The results (i.e. “charts”) are preferably provided as graphical output on a display device. Additionally or alternatively, the results can be stored in memory for subsequent display or use for other purposes.

In overview, the exemplified embodiments of the invention use a “mixer” computer program module to overlay multiple segments of one or more date series (e.g. financial time series) on a chart that can e.g. be displayed to a user in order that trends in the data can be determined and analysed by the user. The segments to be overlayed in the mixer application can be selected from the one or more data series based on “decision points” (‘DPs’)—i.e. specific points in the continuum of the data series—that themselves are determined by the output from one or more “scenario filters”, as discussed in more detail in the examples below.

### Analysis of Dependencies

To determine dependencies between time series, the program of this embodiment can be used to investigate correlations between different curves (each curve representing a time series).

This analysis is carried out within the context of a ‘project’ defined by certain parameters. Specifically, each project consists of data sources, optional scenario filters and mixers.

A data source may consist of a SQL statement and optional parameters used to query a database for the data which has to be analyzed inside the project.

A scenario filter can be used to define a context in which the target curve (i.e. the curve representing the time series for which it is desired to forecast future values) will be analyzed.

The mixer is used to analyse the target curve (e.g. the average developing of the target curve) inside the given context.

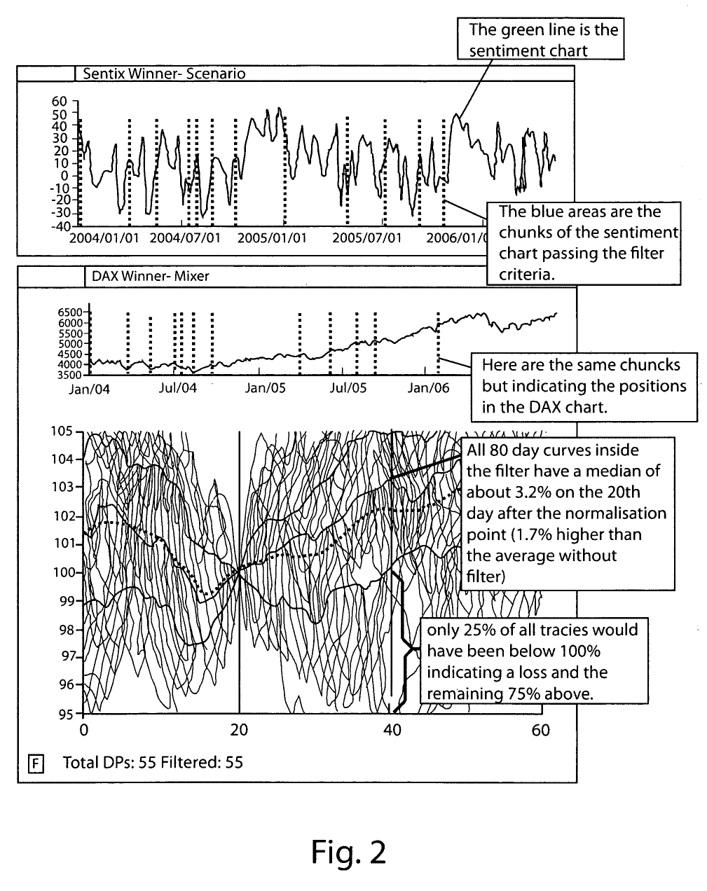

To take an example, if an analyst wants to have an answer to the question “How will the DAX perform in the next two month given that the sentiment of the investors has just changed from slightly pessimistic to neutral?”. The final result of the analysis, conducted in accordance with an embodiment of the invention, may be presented in chart form as seen in FIG. 2.

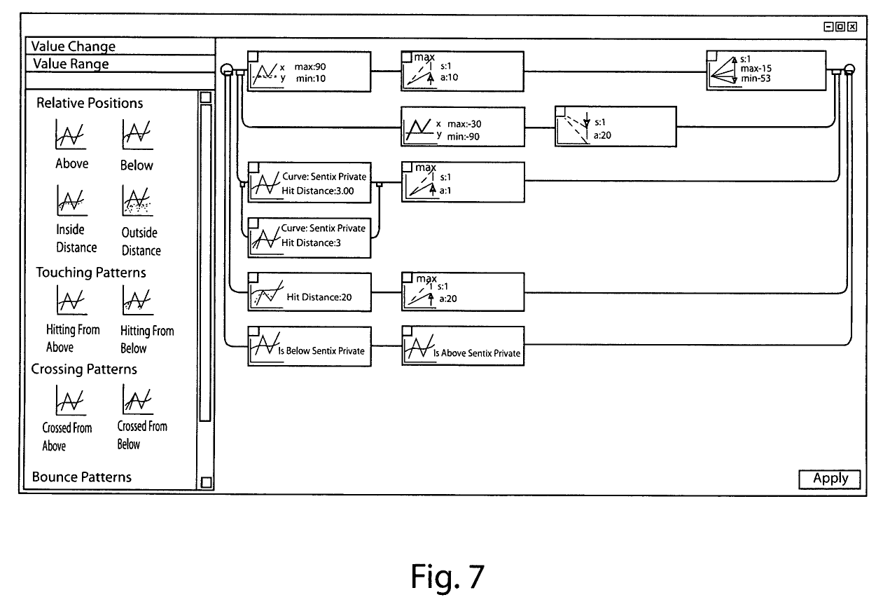

Looking more closely at FIG. 2 and also with reference to FIG. 6, the first (upper) chart window is the sentiment chart. A filter is applied to the sentiment chart using the parameters: “the sentiment climbed more than 10 points and is inside the range of −15 to +15 points.” This corresponds to the desired context for the analysis of an investor sentiment change from slightly pessimistic to neutral. Data points in the investor sentiment time series that pass this filter are highlighted with vertical bands (the chart itself shows the complete time series for a given time period).

The series of bands, corresponding to specific weekly data points in the sentiment series, is then applied as a filter to the DAX series. The upper chart in the lower (“mixer”) window seen in FIG. 2 shows the same bands seen in the sentiment chart applied to the DAX series over the same time period. The parts (in this example weeks) of the DAX series identified by this filter (i.e. the daily DAX data points for each day in each week in which investor sentiment satisfied the context criteria above) are the ones used in the subsequent steps of the analysis process to investigate the correlation between the two curves in the filtered time periods.

More specifically, for each of the DAX data points passed by the filter (referred to as ‘decision points’—DP), a 60 day segment of the DAX time series around that point is selected (20 days up to the decision point and 40 days after the decision point).

Each selected segment is normalized to its decision point so that the decision point for each segment will be 100% and the other values of the points within the segment set relative to that.

The interval length of the segments and the position of the DP within a segment can be chosen freely, e.g. by the user based on the scenario to be analysed.

The normalised segments of the DAX series can be represented as curves, referred to as ‘decision point curves’ (DPC).

The lower of the two charts in the mixer window (FIG. 2) shows the mixer blending all of the 60 day interval curves (light blue lines) created for the DPs (i.e. DAX data points that have passed the filter). There is one 60 day interval curve (DPC) for every day passing the scenario filter.

The dark blue lines represent the 25, 50 and 75% median and the yellow line the mean performance of the DAX (averaged over all of the DPCs).

Many of the DPCs are overlapping with each other so that one day of the DAX may be included more than once (and quite possibly many times) in the mixer chart and therefore in the calculation of the averages. But no point (day) is represented more than once at the same position in the mixer chart.

There is a lot of information that an analyst can gain from the mixer chart. Some of the more important ones, taking the specifically illustrated example, are:
1. The positions of the filtered chunks are distributed more or less equally over the researched time span (here 2004 up to start of 2006). This means the analyst can justifiable assume that the analysis is representative of the overall 2 year period of the DAX that is being examined. If it was not, they may choose to stop the analysis there.
2. There are 55 DPs passing the filter from a total of 652 data points in the overall series being examined. This is 8.4%, from which the analyst can conclude the filtered data is sufficient to be representative. If the percentage of points passing the filter were less than 5% the analyst may conclude straightaway that the filtered data is not representative and stop the analysis.
3. 50% of all DPCs raised by about 3.2% in 20 days. This is about 1.7% more than the average raise of the DAX in any 20 day interval (which was 1.5%).
4. Only 25% percent of all DPCs where below 100% on the 20^{th} day after the decision point. That means only 25% of all DPCs would have caused a loss of money over that period.

An overall conclusion that an analyst might reach based on the mixer chart produced in accordance with an embodiment of the invention might be: “If the sentiment raises from negative to neutral one can expect a raise of 3.2% of the DAX within the next 20 days.”

It can be seen, therefore, that the analysis approach provided by this embodiment of the present invention helps to give answers to very complex questions. The result is easy to interpret and it is also easy to check the statistical relevance of the result for the given scenario.

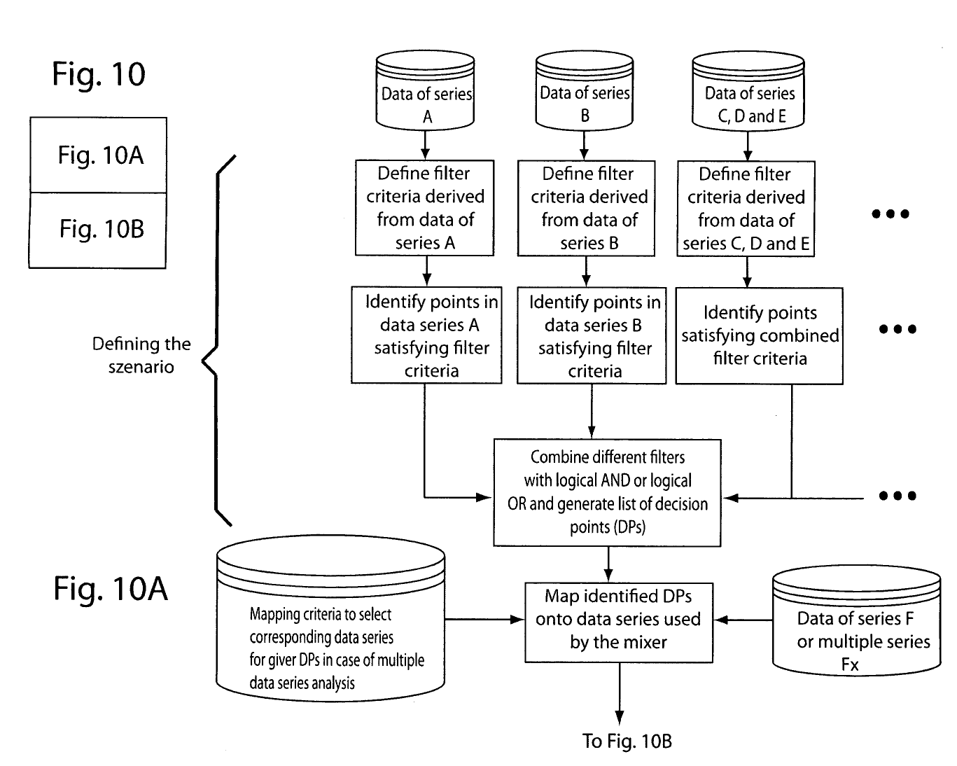

FIG. 9 shows an overview of the process described above.

### Feedback Features

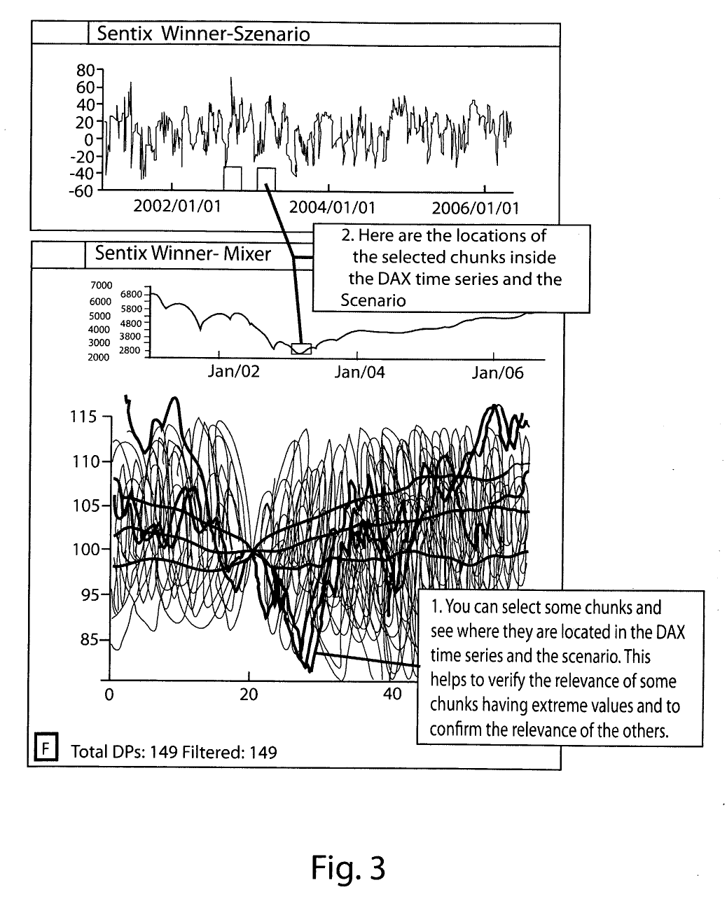

Another feature of embodiments of the present invention, illustrated with reference to FIG. 3, is the possibility to select one or more segments (DPCs) in the mixer chart and have the position of those segments highlighted in the chart of the overall DAX series and the scenario chart (i.e. the investor sentiment chart). This is a very quick way to check, for example, if extreme values are relevant or occurred during extremely bad economic or political conditions and therefore are not relevant for normal conditions.

The ability to select and highlight (e.g. in a different colour) particular segments itself is also a very useful feature, because it makes the complete segment visible when it might otherwise not be, especially if there are a large number of segments represented by DPCs in the mixer chart.

### Analysis of Seasonal Variations

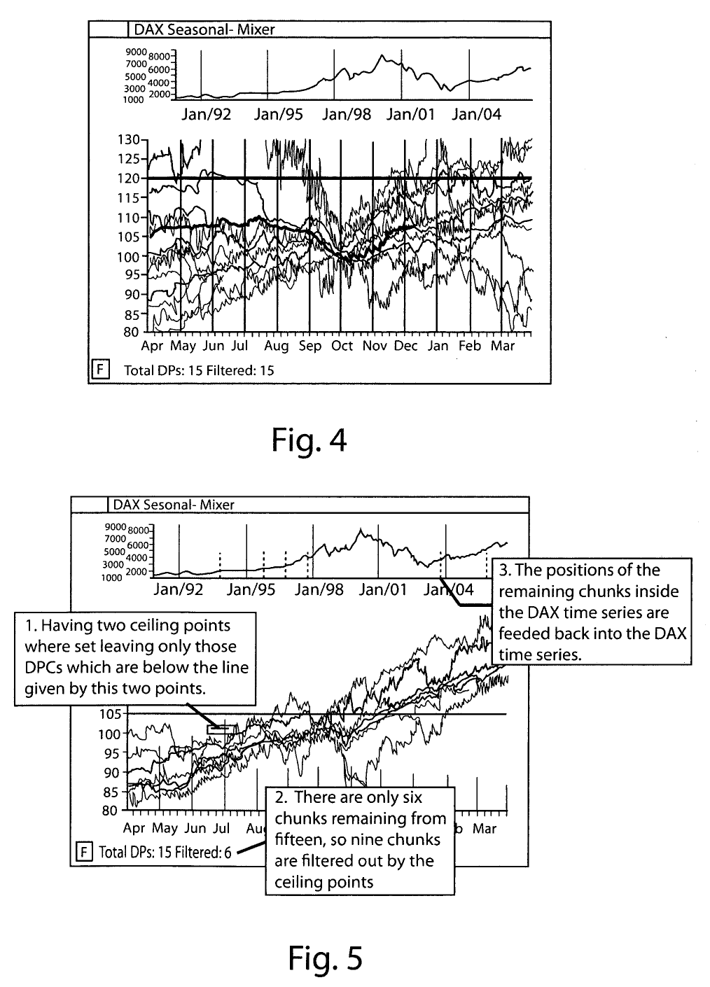

FIG. 4 illustrates a mixer window in accordance with another embodiment of the invention. In the specifically illustrated example, there is shown the seasonal analysis of the DAX from 1991 to 2006, each year being represented by a curve in the (lower) mixer chart (the upper chart shows all of the analysed years in a conventional, linear fashion). Each segment may comprise data for a whole year. In other examples the segments may comprise data for less than a whole year or more than a whole year.

The normalization point is set to 1^{st} of October.

The green line in the mixer chart is the current year (2006). The yellow line is the mean. The purple lines are the 25%, 50% and 75% medians.

What can be seen is that:
In average (mean) the prices fall from mid of July until start of October but
The median (50^{th} percentile) doesn't fall but increases by about 3% from mid August to mid September, so the fall of the average (mean) must be caused by a few exceptionally big drops (e.g. 2001, 2002).
The mean and median indicate a rise of stocks from October until March of about 14%.
The current year (green line) had an unusually big drop in between May and July.

An overall conclusion that might be reached by an analyst is that if you want to invest into the German stock market you should do so in October.

### Further Analysis Abilities

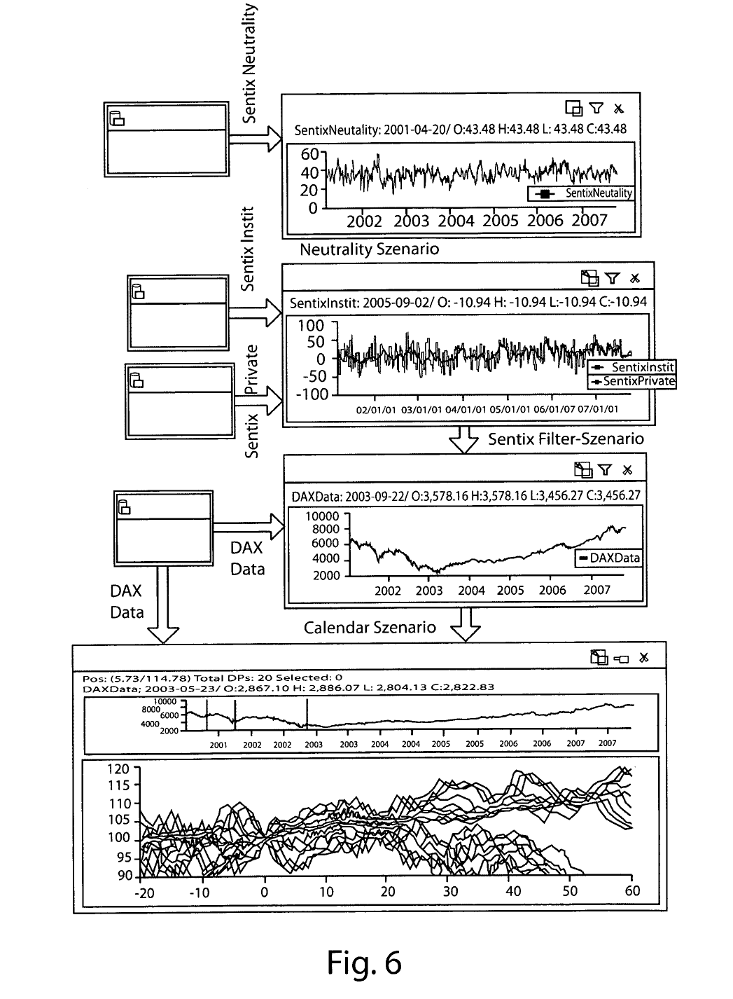

FIG. 5 shows again the DAX seasonal analysis but this time with a filter of ceiling points applied inside the mixer.

This provides an easy way to pass through a filter only those segments that have a similar development to the current one (e.g. in this case all segments which have been below 100% in July compared to October).

In this way, an analyst can see how many segments are left from the total number of segments and therefore estimate how relevant the result will be.

Further it can be seen where the remaining segments are located in the DAX time series. The locations can also be fed back into the scenarios if used.

The filtered analysis also shows a strong rise of the DAX, so there is no reason to assume something different for this year.

Example of an Analysis with Several Filters

FIG. 6 shows an example of an analysis which uses three different scenario filters. The first (Neutrality—Szenario) is used to select only those days where the number of neutral investors are very high. This filter is passed to the next filter (Sentix Filter—Szenario) which selects days (from those remaining after the first filter) where the sentiment of the institutional investors is lower than the sentiment of private investors. The combined filtered results are then passed to the third filter (Calendar—Szenario) which can be used to limit all DPs (Decision Points) to certain years or quarters or any other date range. In this example, the filters are connected in series and so “anded” together thus reducing the remaining days with every step. It is also possible to connect all or some filters in parallel which would “or” them together and so having as result all DPs which pass one filter “or” the other one.

By combining multiple filters in this way, and using in the filters any number of data series, it becomes possible to define a great variety of scenarios (e.g. questions) to be analysed in the mixer.

In the given example the scenario (i.e. question) defined by the three filters (and the data series they operate on) could be “What happens with the DAX in the third quarter if more than 40% of all investors have been neutral and the sentiment of the institutional investors has been lower than the sentiment of the private investors. It can be seen that in this example three time series other than the DAX are used, along with the calendar filter (which is a non time series based filter) to analyse the development of the DAX and provide useful information to the user (e.g. a financial analyst).

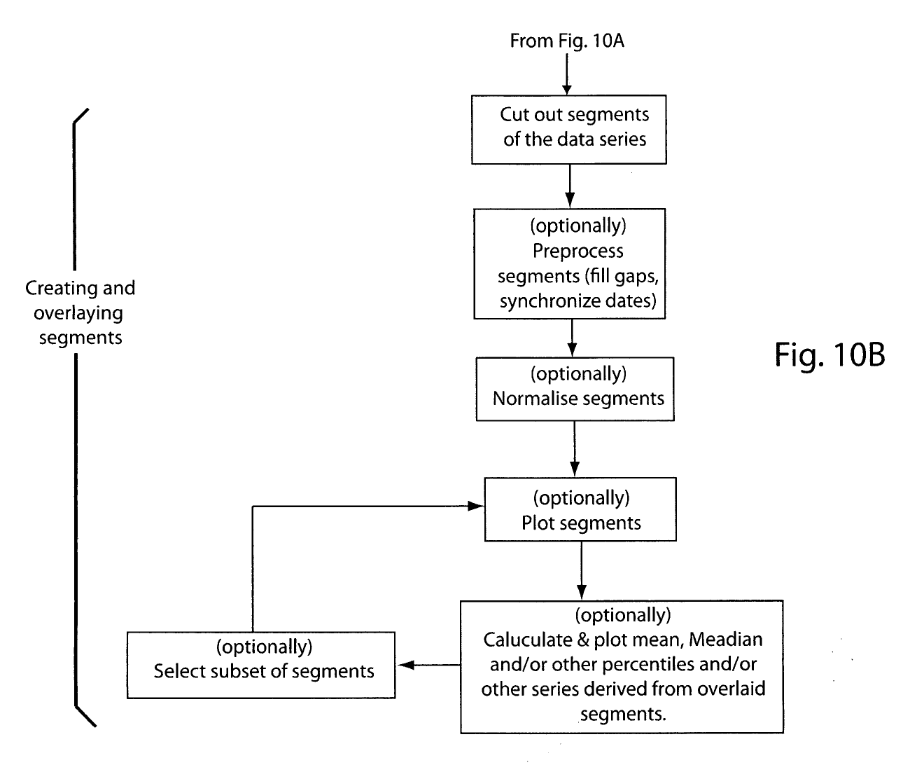

FIG. 10 provides an overview of a process using multiple filters in the manner discussed above.

### Analysis of Multiple Time Series

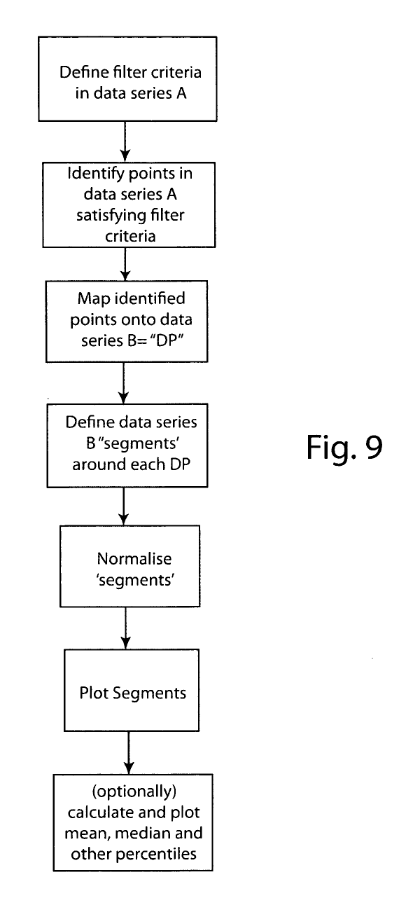

Often analysts wants to know what happens with a group of time series (e.g. all stocks of the DAX) under some certain conditions (e.g. after dividend payment or after a positive, negative or neutral rating was published (FIG. 8)). In the later case the analyst will have a list with published ratings showing the date, the result of the rating and the company to which the rating refers. The ratings in the list will refer to different companies and thus to get a picture of how a certain rating affects the future developing of the stocks the mixer must overlay segments of the time series of all stocks to which a rating was made. The segments taken are the segments around every publication of a rating from the company referenced by the rating. E.g. given the following list of ratings: BMW 2006-02-14 positiv, Daimler 2006-05-24 negativ, BMW 2006-06-10 positiv, two segments of the stock time series from BMW and one from Daimler would be taken and overlaid.

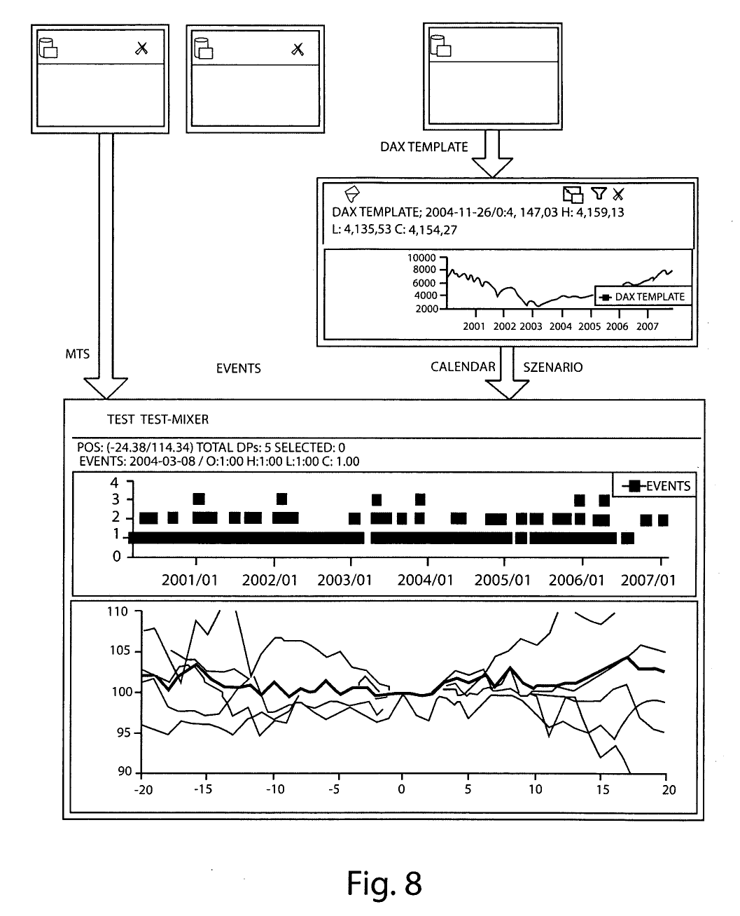

To define the filters to be used in the various embodiments discussed above a user can, for example, use a graphical interface such as the one illustrated in FIG. 7. Elements to make up a filter can be dragged from the left-hand pane and dropped into the right-hand, filter definition pane, for instance. Specific properties for each instance of each element in the filter definition pane can be set by the user.

A will be understood by the skilled person, various modifications to the specifically described embodiments can be made without departing from the scope of the present invention.

1. A charting method comprising selecting a plurality of segments of a data series and plotting the segments on a chart, the segments being overlaid on one another on the chart.

2. A charting method according to claim 1, wherein the data series is a time series.

3. A charting method according to claim 1, wherein the number of overlaid segments of the data series is five or more.

4. A charting method according to claim 3, wherein the number of overlaid segments of the data series is 7 or more or 13 or more.

5. A charting method according to claim 3, wherein the number of overlaid segments of the data series is 20 or more.

6. A charting method according to claim 3, wherein the number of overlaid segments of the data series is 50 or more.

7. A charting method according claim 1, wherein the overlaid segments of the chart are plotted to the same scale as one another to enable their direct comparison.

8. A charting method according to claim 1, wherein all of the segments are the same length as one another.

9. A charting method according to claim 8, wherein each of the segments contains the same number of data points as each of the other segments.

10. A charting method according to claim 1, wherein the values of the data series within each segment are normalised about a selected point in the segment, the selected point being the same relative point within each segment, so all of the overlaid segments coincide at that point on the chart.

11. A charting method according to claim 1, comprising calculating one or more statistical functions derived from the selected segments of the data series and overlaying the or each statistical function on the chart.

12. A charting method according to claim 11, wherein the indicator(s) are any one or more of a mean, median, other percentile of the points in all of the plotted segments, and standard deviations of the points in all of the plotted segments.

13. A charting method according to claim 11, wherein only the indicator(s) are displayed.

14. A charting method comprising selecting a plurality of segments of a data series, deriving collectively from all of the selected segments one or more statistical functions and plotting said one or more statistical functions on a chart.

15. A charting method according to claim 14, wherein the data series is a time series.

16. A charting method according to claim 14, wherein the one or more statistical functions are selected from the mean or median or another percentile of corresponding points in each of the data series segments.

17. A charting method according to claim 14, wherein one or more of the underlying data series segments are also be plotted on the chart.

18. A charting method according to claim 11, wherein the statistical functions are shown as visually distinguishable band representing bands of values for the function.

19. A charting method according to claim 1, wherein the data series segments are selected based on a filter defined by a user, the filter defining a set of one or more selection criteria for the segments.

20. A charting method according to claim 1, wherein the data series segments are selected automatically based on a predefined filter, the filter defining a set of one or more selection criteria for the segments.

21. A charting method according to claim 19, wherein the selection criteria relate to the data series itself.

22. A charting method according to claim 21, wherein the data series is a time series and the segments are selected to consist of data for two or more consecutive years in order to examine seasonal variations in the time series.

23. A charting method according to claim 22, wherein the consecutive years are calendar years.

24. A charting method according to claim 22, wherein the consecutive years are not calendar years.

25. A charting method according to claim 19, wherein the selection criteria relate to one or more other data sources.

26. A charting method according to claim 25, wherein the selection criteria relate to said one or more other data series in order to investigate dependencies between the two or more data series.

27. A charting method according to claim 1, wherein the segments of the data series are consecutive, non-overlapping chunks of the data series.

28. A charting method according to claim 1, wherein the segments are spaced from one another in the data series.

29. A charting method according to claim 1, wherein the segments overlap one another

30. A charting method according to claim 1, wherein the segments include any one or more of segments that are spaced from one another, segments that overlap one another and segments that follow consecutively one from the other in the overall data series.

31. A charting method according to claim 1, wherein the plurality of data segments are selected from multiple data series.

32. A charting method according to claim 19, wherein the application of the filter first results in the identification of specific decision points in a data series satisfying the filter selection criteria, a segment subsequently being defined about each identified decision point.

33. A charting method according to claim 32, wherein each segment is defined as the chunk of the data series represented by a predetermined length before and/or after the decision point.

34. A charting method according to claim 32, wherein the data points in each segment are normalised based on the value of the series at the respective decision point.

35. A method for filtering data series data, the method comprising identifying in the data series data one or more data points satisfying predetermined filter criteria and defining a corresponding one or more data series data segments comprising a respective one of the identified data points and one or more preceding data points from the series and/or one or more succeeding data points from the series.

36. A method according to claim 35, wherein the data series is a time series.

37. A method according to claim 35, wherein all of the selected data segments are the same length.

38. A method of determining data points for subsequent use in selecting a plurality of data segments from one or more data series, the method comprising identifying in one or more data series one or more data points satisfying predetermined filter criteria and recording the identified data points for subsequent use in selecting a plurality of segments in another data series.

39. A method according to claim 38, wherein the data series are time series and the identified data points are specific points in time.

40. A method according to claim 38, wherein the predetermined filter criteria comprise multiple separate filters.

41. A method according to claim 1, wherein the data series is a financial time series.

42. A method according to claim 41, wherein the financial time series is selected from stock exchange indices, stock prices, derivative prices and exchange rates.

43. A computer system adapted to operate a charting method according to claim 1, the system comprising means for selecting a plurality of segments of a data series and means for plotting the segments on a chart overlaid on one another.

44. A computer system adapted to operate a charting method according to claim 14, the system comprising means for selecting a plurality of segments of a data series, means for deriving collectively from all of the selected segments one or more statistical functions and means for plotting said one or more statistical functions on a chart.

45. A computer system adapted to operate a filtering method according to claim 35, the system comprising means for identifying in data series data one or more data points satisfying predetermined filter criteria and means for defining a corresponding one or more data series data segments comprising a respective one of the identified data points and one or more preceding data points from the series and/or one or more succeeding data points from the series.

46. A computer system adapted to operate a method according to claim 38, the system comprising means for identifying in one or more data series one or more data points satisfying predetermined filter criteria and means for recording the identified data points for subsequent use.

47. A computer program comprising computer program code that when executed on a computer or computer network causes the computer or computer network to operate in accordance with the method of claim 1.
